(19) United States
(12) Patent Application Publication
(10) Pub. No.: US 2026/0043517 A1
(43) Pub. Date: Feb. 12, 2026

(54) POWER TOOL SAFETY PERIMETER USING WIRELESS BOUNDARY MARKERS

(71) Applicant: Milwaukee Electric Tool Corporation, Brookfield, WI (US)

(72) Inventor: Christian A. Castro, Deerfield, IL (US)

(21) Appl. No.: 19/293,190

(22) Filed: Aug. 7, 2025

Related U.S. Application Data
(60) Provisional application No. 63/680,726, filed on Aug. 8, 2024.

(51) Int. Cl. F16P 3/14

(52) U.S. Cl. CPC F16P 3/144

(57) ABSTRACT

Power tool safety perimeter systems and methods are provided herein. The system includes a wireless boundary marker and a power tool. The wireless boundary marker includes a boundary crossing sensor, a marker wireless radio, and a marker electronic controller. The marker electronic controller receives an output from the boundary crossing sensor indicating that a boundary has been crossed by an object, and transmits, via the marker wireless radio, an indication that the boundary has been crossed. An electronic tool controller of the power tool receives a message, via a tool wireless radio, indicating that the wireless boundary marker detected that the boundary was crossed, and controls the power tool responsive to the message.

### RELATED APPLICATIONS

This application claims priority to U.S. Provisional Application No. 63/680,726, filed on Aug. 8, 2024, titled “POWER TOOL SAFETY PERIMETER USING WIRELESS BOUNDARY MARKERS,” which is hereby incorporated by reference in its entirety.

### BACKGROUND

Power tools can be used for various applications in different environments. To provide a safe environment surrounding the power tools, various devices responsible for performing safety procedures may be implemented.

### SUMMARY

Some embodiments of the disclosure provide a power tool safety perimeter system. The system includes a wireless boundary marker comprising: a boundary crossing sensor, a marker wireless radio, and a marker electronic controller. The marker electronic controller includes a first processor and is coupled to the boundary crossing sensor and the marker wireless radio. The marker electronic controller is configured to: receive an output from the boundary crossing sensor indicating that a boundary has been crossed by an object, and transmit, via the marker wireless radio, an indication that the boundary has been crossed. The system further includes a power tool comprising: a motor, a tool wireless radio, and an electronic tool controller. The electronic tool controller includes a second processor and is coupled to the motor and the tool wireless radio. The electronic tool controller is configured to: receive a message, via the tool wireless radio, indicating that the wireless boundary marker detected that the boundary was crossed, and control the power tool responsive to the message.

Some embodiments of the disclosure provide a method comprising: receiving, by a marker electronic controller of a wireless boundary marker, an output from a boundary crossing sensor of the wireless boundary marker indicating that a boundary has been crossed by an object; transmitting, via a wireless radio of the wireless boundary marker, an indication that the boundary has been crossed; receiving, via a tool wireless radio of a power tool device, a message indicating that the wireless boundary marker detected that the boundary was crossed; and controlling, by an electronic tool controller of the power tool device, the power tool device responsive to the message.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 shows a system diagram of a power tool safety perimeter system, according to some examples.

FIG. 2 shows an example of the power tool safety perimeter system of FIG. 1, according to some examples.

FIG. 3 shows a block diagram of a power tool device, according to some examples.

FIG. 4 shows a block diagram of a boundary marker system, according to some examples.

FIG. 5 shows a block diagram of a user device, according to some examples.

FIG. 6 shows a flowchart of a process for performing boundary sensing, according to some examples.

FIGS. 7A and 7B show an example of an individual crossing a perimeter of a boundary marker system, according to some examples.

### DETAILED DESCRIPTION

As described above, power tools can be used for various application in different environments. Individuals and objects that enter an area nearby a user with a power tool device may be at risk of coming into contact with the power tool device or the user, which can create a dangerous situation and impact the work being performed. The potential danger and impact of these situations can be reduced by identifying when an object and/or individual enters an area or work environment nearby a user with a power tool device and taking responsive action.

Some embodiments described herein provide a safety perimeter in an area near or surrounding one or more power tool devices. For example, some embodiments of the disclosure provide a power tool safety perimeter system that defines and monitors a perimeter around a user operating a power tool. The power tool safety perimeter system may sense and indicate when the perimeter is crossed, causing, for example, an alert on a user device, control of the power tool device (e.g., to stop or slow a motor of the power tool device, and/or generate an alert), or another predetermined action.

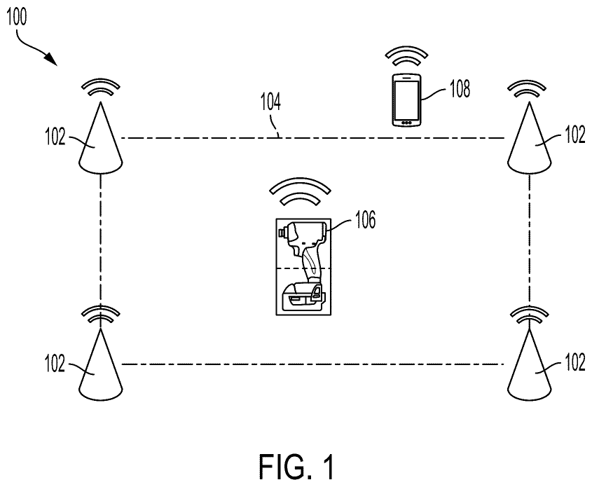

FIG. 1 illustrates a system diagram of a power tool safety perimeter system 100. As illustrated in FIG. 1, the power tool safety perimeter system 100 includes safety cones 102 that form a perimeter 104, a power tool device 106, and a user device 108. Although four safety cones 102 are illustrated in FIG. 1, in some examples, the power tool safety perimeter system 100 includes fewer or more safety cones 102. Additionally, in some examples, the power tool safety perimeter system 100 includes more than one power tool device 106, and/or more than one user device 108.

The safety cones 102 may act as boundary markers to define or form a safety perimeter (e.g., the perimeter 104) surrounding or defining a working environment of the power tool device 106. For example, in some examples, the perimeter 104 has a polygon shape, where each safety cone 102 defines a vertex of the polygon shape, and each edge of the polygon shape is defined between two of the safety cones. For example, with reference to FIG. 1, each safety cone 102 corresponds to one of the four vertices of the perimeter 104 that has a rectangular shape. However, in other examples, three of the safety cones 102 may form a triangle-shaped perimeter, five of the safety cones 102 may form a pentagon-shaped perimeter, six safety cones 102 may form a hexagon-shaped perimeter, and so on. In other examples, the perimeter 104 has a non-polygonal shape. For example, the perimeter 104 may be a line segment between two safety cones or may be a series of segments defined by three or more safety cones (e.g., that do not ultimately form a closed polygonal chain). In some examples, the perimeter 104 has a convex polygonal shape, a concave polygonal shape, a complex polygonal shape, a three-dimensional polygonal shape (e.g., a polyhedron shape), includes multiple polygonal shapes (e.g., each defined by a set of safety cones 102), and/or includes a combination of non-polygonal and polygonal shapes.

The safety cones 102 may also be referred to as wireless boundary markers. In some examples, the safety cones 102 are not cone-shaped but, rather, have another form (e.g., cuboid, cylindrical, or a combination thereof). The perimeter 104 may also be referred to as a virtual perimeter, fence, or boundary.

One or more of the safety cones 102 may wirelessly communicate with the power tool device 106 and/or the user device 108 (e.g., via a Bluetooth radio module, a Wi-Fi radio module, a Zigbee radio module, or the like). As described further herein, the safety cones 102 may detect when the perimeter 104 is crossed by an object (e.g., by an individual, an animal, or an inanimate object) and wirelessly communicate an indication that the perimeter 104 has been crossed to another device (e.g., the power tool device(s) 106 within the perimeter 104 and/or the user device(s) 108).

As illustrated, the power tool device 106 is a motorized power tool. That is, the power tool device 106 includes a motor. In some examples, the power tool device 106 is another type of motorized power tool. Each type of motorized power tool can include a moveable component and an actuator (e.g., a motor) that can move (e.g., translate, rotate, reciprocate, oscillate, etc.) the moveable component to implement a functionality on a workpiece. For example, a motorized power tool can be a drill, an impact driver, a crimper, a cutter, a reciprocating saw, a circular saw, a chainsaw, a pump, a fan, or the like. In other examples, the power tool device 106 is a nonmotorized power tool. Each non-motorized power tool can lack a motor, a moveable component, etc., and thus can lack the ability to implement a functionality on a workpiece. For example, a non-motorized power tool can be a radio, a light, a speaker, a power supply (e.g., a portable power supply), or the like. Thus, although shown as a particular type of power tool in FIG. 1, the power tool device 106 can be implemented as various types of power tools, including as a motorized power tool or a non-motorized power tool. As used herein, a “power tool device” may include a power tool (whether motorized or non-motorized), a power tool battery pack, a power tool battery pack charger, or a combination thereof.

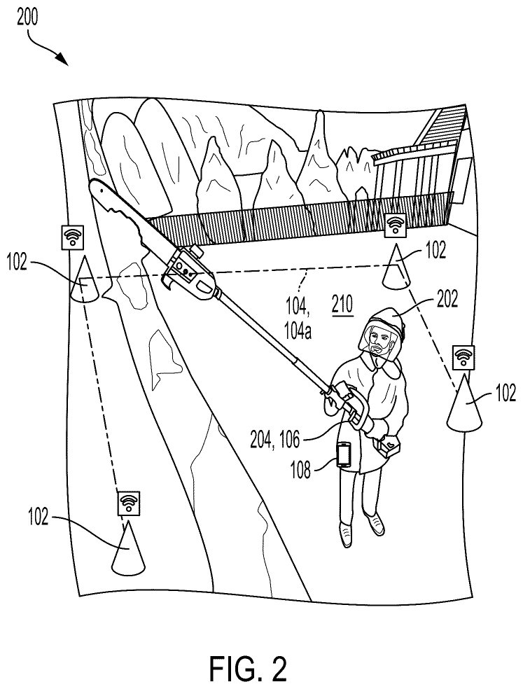

FIG. 2 illustrates a safety perimeter system 200, which is an example embodiment of the power tool safety perimeter system 100. In particular, FIG. 2 shows a chainsaw power tool 204 (as the power tool device 106) in use with the power tool safety perimeter system 100, including the safety cones 102 and a perimeter 104a. The perimeter 104a is an example of the perimeter 104. In the illustrated example, the perimeter 104a includes three line segments defined by four of the safety cones 102. References to the perimeter 104 herein similarly apply to the perimeter 104a, unless otherwise noted. As shown in FIG. 2, a power tool device user 202 is operating the chainsaw power tool 204 to cut into a tree branch. The power tool device user 202 and the chainsaw power tool 204 may create an environment 210 with falling branches and debris. Moreover, the power tool device user 202 may be unaware of individuals or other objects crossing the perimeter 104a while the user 202 is using the chainsaw power tool 204. Therefore, in some examples, when the perimeter 104a is crossed, the power tool safety perimeter system 100 may send an indication to the user device 108 of the power tool device user 202 and/or to the chainsaw power tool 204 in response to sensing the perimeter 104a has been crossed. For example, in response to the indication, the user device 108 may generate an alert, and/or the chainsaw power tool 204 may cease its cutting operation. In other examples, other forms of actions and/or notifications may be triggered when the perimeter 104 is crossed, as described in more detail below.

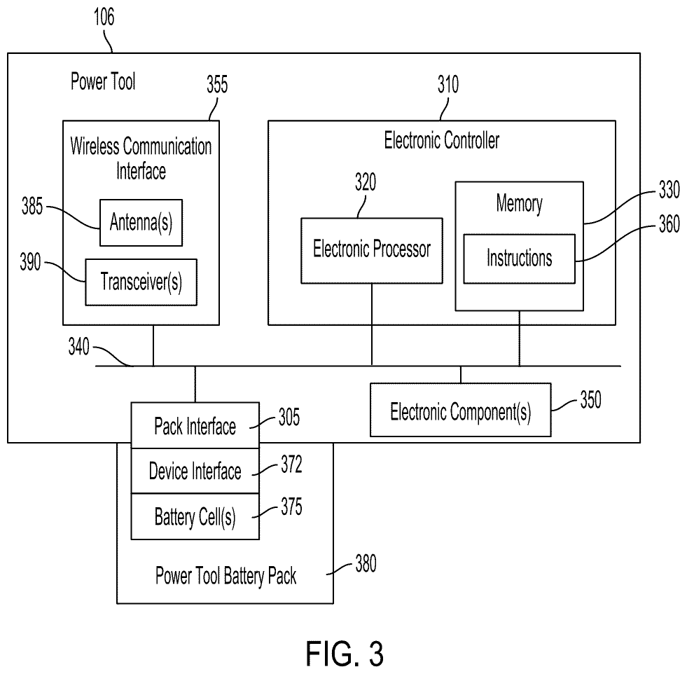

FIG. 3 illustrates a block diagram of the power tool device 106 included in the power tool safety perimeter system 100 of FIGS. 1 and 2 according to some configurations. The power tool device 106 includes a pack interface 305, an electronic controller 310 with an electronic processor 320 and a memory 330, a communication bus 340, one or more electronic components 350, and a wireless communication interface 355. The electronic processor 320, the memory 330, the electronic component(s) 350, and the wireless communication interface 355 may communicate over one or more control and/or data buses (for example, the communication bus 340).

The memory 330 may include read-only memory (ROM), random access memory (RAM), other non-transitory computer-readable media, or a combination thereof. The memory 330 may include instructions for the electronic processor 320 to execute. Alternatively, or in addition, the memory 330 may include tool perimeter settings. The tool perimeter settings may be specific to the power tool device 106. As described herein, tool perimeter settings may include one or more predetermined actions that the electronic controller 310 should take in response to a message indicating that a boundary crossing has occurred, as described in further detail below. In some examples, the memory may store a mapping of various particular actions that the electronic controller 310 should take in response to various types of additional information provided with a message indicating that a boundary crossing has occurred. Thus, the particular action(s) implemented by the electronic controller 310 can vary based particular details of the boundary crossing, message, or other settings. The tool perimeter settings may be initially set and revised by the user device 108. For example, the user device 108 may present a graphical user interface to receive user input that specifies the tool perimeter settings. The user device 108 may then transmit the tool perimeter settings to the wireless communication interface 355 such that the electronic controller 310 may store the tool perimeter settings in the memory 330. Thus, a user is able to customize the particular actions taken by the power tool device 106 in response to a boundary crossing or type of boundary crossing.

The electronic processor 320 may be configured to communicate with the memory 330 to store settings and instructions. The electronic processor 320 may be configured to receive the instructions 360 and data from the memory 330 and execute, among other things, the instructions associated with the tool perimeter settings and/or mobile device perimeter settings, as described above. In some examples, through execution of the instructions by the electronic processor 320, the electronic controller 310 may perform one or more of the methods described herein. For example, the electronic processor 320 may receive an identification of the power tool device 106 and execute rules and/or tasks corresponding to the settings for the power tool device 106, including software executable by the electronic processor 320 to enable the electronic controller 310 to, among other things, implement the various functions of the electronic controller 310 described herein, including collecting and tracking tool information, providing perimeter sensor information to an external device (e.g., the user device 108), and responding to indications of perimeter crossings, as described in greater detail herein. In some examples, the electronic processor 320 includes one or more electronic processors.

The power tool device 106 includes the pack interface 305 for selective attachment and detachment to/from a device interface 372 of a power tool battery pack 380 and for selective attachment and detachment from the power tool device 106. The pack interface 305 may include one or more power terminals and, in some cases, one or more communication terminals that interface with respective power and/or communication terminals of the device interface 372. The power tool battery pack 380 includes the device interface 372 for selective attachment and detachment to/from the pack interface 305 of the power tool device 106. The power tool battery pack 380 may include one or more battery cells 375.

The electronic components 350 may vary depending on a type of the power tool device 106. As one example, the electronic components 350 may include a switching circuit and a motor. The switching circuit may include one or more power switching elements (e.g., field effect transistors (FETs), bipolar junction transistors (BJTs), or the like), which may be arranged as a switch bridge. The electronic controller 310 may control the switching circuit to provide power from the power tool battery pack 380 to the motor to drive the motor. The motor may be a permanent magnet brushless motor, a brushed motor, or another type of motor. As another example, the electronic components 350 may include a switching circuit and an output circuit. The switching circuit may include a one or more power switching elements (e.g., field effect transistors (FETs), bipolar junction transistors (BJTs), or the like), which may be arranged as a switch bridge. The electronic controller 310 may control the switching circuit to provide power from the power tool battery pack 380 to the output circuit to drive the output circuit. The output circuit may include a power-driven output element, for example, one or more of a work light, a radio circuit, a speaker, a microphone, a sensor circuit, a display, among other elements.

The wireless communication interface 355, also referred to as a tool wireless radio, may enable the power tool device 106 to communicate with an external device (e.g., the user device 108) via a wireless communication connection (or channel). While the wireless communication interface 355 is described herein as enabling the power tool device 106 to wirelessly communicate with the safety cones 102 and the user device 108, the wireless communication interface 355 may be configured to enable the power tool device 106 to wirelessly communication with another external device, such as, e.g., another power tool device 106.

In some configurations, the wireless communication interface 355 may include a transceiver 385 (e.g., a radio transceiver) and an antenna 390 to send and receive wireless messages to and from the safety cones 102 and/or the user device 108. For example, an electronic controller associated with the wireless communication interface 355 may buffer incoming and/or outgoing data, communicate with the electronic controller 310, and determine the communication protocol and/or settings to use in wireless communications.

In some configurations, the wireless communication interface 355 may be a Bluetooth® communication interface (i.e., facilitate Bluetooth® communication). For instance, the Bluetooth® interface may communicate with the safety cones 102 employing the Bluetooth® protocol. Therefore, in some configurations, the safety cones 102 and the power tool device 106 may be in proximity of each other during the exchange of data. In other embodiments, the wireless communication interface 355 communicates using other protocols (e.g., Wi-Fi, cellular protocols, Zigbee, etc.) over a different type of wireless network. For example, the wireless communication interface 355 may be configured to communicate via Wi-Fi through a wide area network, such as the Internet or a local area network, or to communicate through a piconet (e.g., using infrared or NFC communications). The communication via the wireless communication interface 355 may be encrypted to protect the data exchanged between the safety cones 102 and the power tool device 106 from third parties.

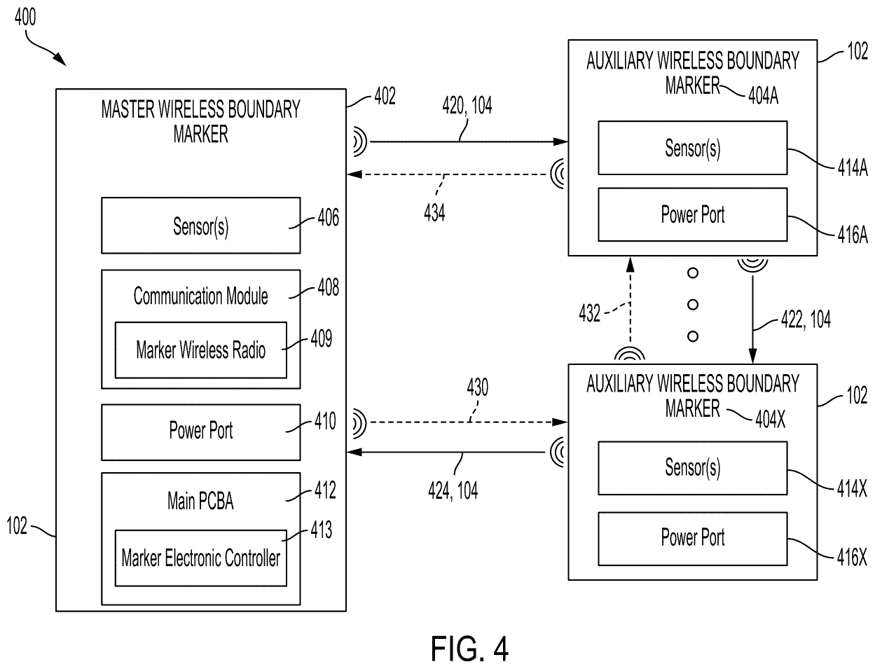

FIG. 4 shows a block diagram of a boundary marker system 400, according to some examples. As shown in FIG. 4, the system 400 includes a master wireless boundary marker 402 and any number of auxiliary wireless boundary marker 404A to 404X, where the varying number of auxiliary wireless boundary markers is indicated in FIG. 4 by the three dots between the auxiliary boundary markers 404A and 404X. The boundary marker system 400 is an example of a group of the safety cones 102 of the system 100 of FIGS. 1-2. That is, each of the master boundary marker 402 and the auxiliary boundary markers 404A to 404X may be one of the safety cones 102, which together define the perimeter 104. Unless otherwise noted, reference herein to the auxiliary boundary markers 404A, 404X is intended to refer to each auxiliary boundary marker in the system 400, including the auxiliary boundary marker 404A, the auxiliary boundary marker 404X, and any intervening auxiliary boundary markers represented by the three dots between the auxiliary boundary markers 404A and 404X in FIG. 4.

The master boundary marker 402 can include one or more sensors 406, a communication module 408, a power port 410, and a main printed circuit board assembly (PCBA) 412. Moreover, the auxiliary boundary marker(s) 404A, 404X can include one or more sensors 414A, 414X and a power port 416A, 416X. Each of the sensors 406 and 414A, 414X may be referred to as a boundary crossing sensor. In some examples, the one or more sensors 406 of the master boundary marker 402 can be wirelessly connected to the one or more sensors 414A, 414X of the auxiliary boundary markers 404A, 404X to form a daisy chain. As described above with respect to FIG. 1, the daisy chain may form a virtual perimeter nearby or at least partially surrounding a power tool device (e.g., the perimeter 104 surrounding power tool device 106). For example, each of the master wireless boundary marker 402 and the auxiliary boundary marker(s) 404A, 404X may be a link in creating the daisy-chain which forms the virtual perimeter.

The communication module 408 includes a wireless radio 409, also referred to a marker wireless radio 409. The marker wireless radio 409 may include, for example, a transceiver circuit with an antenna that enables wireless communication via one or more wireless communication protocols. In some examples, the marker wireless radio 409 may be a Bluetooth radio, a Wi-Fi radio, a Zigbee radio, or the like. For example, the marker wireless radio 409 in the master boundary marker 402 may send an indication, wirelessly, to the user device 108 when a break is sensed in the daisy chain (e.g., when an object crosses the perimeter 104). Additionally or alternatively, the marker wireless radio 409 may also wirelessly send the indication to the power tool device 106. The marker wireless radio 409 enables the master boundary marker 402 to communicate with external devices wirelessly, such as user device 108 and/or power tool device 106.

The main PCBA 412 includes an electronic controller 413, also referred to as the marker electronic controller 413. Similar to the electronic controller 310, the marker electronic controller 413 may include an electronic processor and a memory. The memory may store instructions that the electronic processor executes to carry out the functionality of the marker electronic controller 413 described herein. The marker electronic controller 413 may be coupled to the sensors 406, the marker wireless radio 409 (and, thus, the communication module 408), and the power port 410. The marker electronic controller 413 may control and receive sensor data from the sensor(s) 406. The marker electronic controller 413 may communicate wirelessly with other devices (e.g., other boundary markers 404A, 404X, one or more of the power tool devices 106, the user device 108, etc.) via the wireless radio 409.

In some examples, the sensors 406, 414A, 414X may be or include infrared (IR) sensors. Each of the IR sensors may include an IR transmitter and an IR receiver. In one example, the sensor(s) 406 includes a first IR sensor with a first IR transmitter and a first IR receiver, the sensor(s) 414A includes a second IR sensor with a second IR transmitter and a second IR receiver, and the sensor(s) 414X includes a third IR sensor with a third IR transmitter and a third IR receiver. In this example, the first IR transmitter of the master boundary marker 402 may transmit a first IR signal 420 towards the second IR receiver of the auxiliary boundary marker 404A. In response to the second IR receiver receiving the first signal, the second IR transmitter of the auxiliary boundary marker 404A may transmit a second IR signal 422 to the third IR receiver of the auxiliary boundary marker 404X. In response to the third IR receiver receiving the third signal, the third IR transmitter of the auxiliary boundary marker 404X may transmit a third IR signal 424 to the first IR receiver of the master boundary marker 402. Thus, a daisy chain of IR signals may exist within the system 400, effectively forming the perimeter 104. That is, each IR signal 420, 422, and 424 may form a leg or portion of the perimeter 104.

In some examples, each of the sensor(s) 406, 414A, 414X of the boundary markers 402, 404A, 404X includes an additional IR sensor with an additional IR transmitter and an additional IR receiver (e.g., so that the sensors 406 includes two IR sensors, the sensors 414A includes two IR sensors, and the sensors 414X includes two IR sensors) to enable bi-directional transmissions between the boundary markers 402, 404A, 404X, as illustrated by IR signals 430, 432, and 434. Thus, as illustrated, the additional IR transmitter of the boundary marker 402, 404X, and 404A transmit the fourth IR signal 430, the fifth IR signal 432, and the sixth IR signal 434, respectively, which are received by the additional IR receiver of the boundary marker 404X, 404A, and 402, respectively.

When other auxiliary wireless boundary markers in addition to the auxiliary wireless boundary markers 404A and 404X are present, each may include one or more IR sensors that function similarly to enable such additional auxiliary wireless boundary markers to serve as intermediate markers forming additional legs or portions of the perimeter 104.

As explained in further detail below, when an object crosses the perimeter 104, one of the IR signals (e.g., IR signal 420, 422, or 424) may be blocked by the object, which the system 400 can detect (e.g., because an IR receiver does not receive the IR signal). For example, the IR signal may be interrupted by the object, therefore preventing the IR receiver from receiving the IR signal.

In some examples, the system 400 generates the perimeter 104 (and signals 420-424 and/or 430-434) using another type of wireless signal other than an IR signal in an infrared spectrum portion of the electromagnetic spectrum. For example, instead of or in addition to the sensors 406 including IR sensors transmitting and receiving IR signals in the infrared spectrum (e.g., with wavelengths between 780 nanometers (nm) and 1 millimeter (mm)), the sensors 406 may include a light sensor that operates in a visible light spectrum (e.g., transmitting light signals in wavelengths between 380-780 nm), or a sensor that operates in another section of the electromagnetic spectrum (e.g., ultraviolet, microwave, radio wave, etc.). Although the wavelength may vary by spectrum type, the general operation of such sensors may be similar to that of the IR sensors described herein.

The power port 410, as well as power ports 416A and 416X may receive power from one or more rechargeable batteries. For example, the power ports 410, 416A, 416X (and, thus, the boundary markers 402, 404A, 404X) may include one or more rechargeable battery cells (e.g., lithium ion cells, nickel cadmium cells, etc.) and/or a power port. In some examples, the port may be connected to an external power supply via a power cable (e.g., a USB cable) and the power ports 410, 416A, 416X can receive power from the power cable and charge the battery cells. When sufficiently charged, the battery cells may power the other components of the boundary marker 402, 404A, 404X in which the battery cells reside. In some examples, one or more of the power ports 410, 416A, 416X include an interface similar to the pack interface 305 of the power tool device 106 and are configured to receive a power tool battery pack 380. In such cases, the power tool battery pack 380 may supply power to the boundary marker 402, 404A, 404X to which it is coupled. The power received and/or provided by the power ports 410, 416A 416X may be used to power the sensors 406, 414A, 414X, as well as the communication module 408 and main PCBA 412, in the case of the master boundary marker 402.

Although the safety cones 102 of the boundary marker system 400 include one master boundary marker 402 and multiple auxiliary boundary markers 404A, 404X, where the auxiliary boundary markers 404A, 404X have reduced hardware, in some examples, each of the safety cones 102 of the boundary marker system 400 is implemented as the master boundary marker 402 (e.g., including similar hardware as illustrated). In such examples, one of the master boundary markers 402 may be identified or selected to serve as a master boundary marker, while the others may serve as an auxiliary boundary marker (e.g., potentially leaving some hardware unutilized or less utilized).

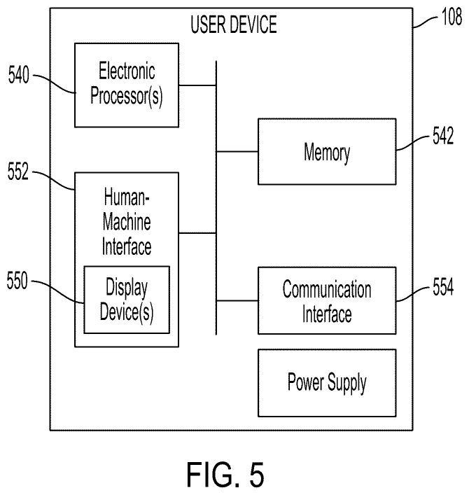

FIG. 5 illustrates a block diagram of an example of user device 108 included in the power tool safety perimeter system 100 of FIG. 1, according to some configurations. The user device 108 may be a computing device and may include a smart phone, a desktop computer, a terminal, a workstation, a laptop computer, a tablet computer, a smart watch or other wearable, a smart television or whiteboard, or the like. As illustrated in FIG. 5, the user device 108 includes an electronic processor 540 (for example, a microprocessor, an application-specific integrated circuit (ASIC), or another suitable electronic device), a memory 542 (for example, a non-transitory, computer-readable medium), a communication interface 544, and a human-machine interface (HMI) 552. The electronic processor 540, the memory 542, the communication interface 544, and the HMI 552 communicate wirelessly, over one or more communication lines or buses, or a combination thereof. It should be understood that the user device 108 may include additional components than those illustrated in FIG. 5 in various configurations and may perform additional functionality than the functionality described herein. For example, in some embodiments, the functionality described herein as being performed by the user device 108 may be distributed among servers or devices (including as part of services offered through a cloud service), may be performed by one or more tool control systems, or a combination thereof.

The communication interface 544 allows the user device 108 to communicate with devices external to the user device 108. For example, as illustrated in FIG. 1, the user device 108 may communicate with the safety cones 102 to receive information regarding the crossing of the perimeter 104. The communication interface 544 may include a transceiver for establishing a wireless connection (e.g., over one or more communication networks, such as the Internet, local area network, a wide area network, a cellular network, and the like), or another form on communication module.

The electronic processor 540 is configured to access and execute computer-readable instructions (“software”) stored in the memory 542. The software may include instructions for executing actions in response to receiving an indication that the perimeter 104 has been crossed. These actions may include, for example, generating an alert (e.g., a visual alert or graphic pop-up a display, an audible alert, and/or a tactile vibration by the user device 108) indicating that the perimeter 104 has been crossed, and/or transmitting a message to the power tool device 106 corresponding to the perimeter 104. The message may cause the power tool device 106 to stop or slow a motor, or otherwise alter operation of the power tool device 106. In some examples, the pop-up may include information regarding credentials of an individual that crossed the perimeter 104.

The memory 542 may store instructions for execution by the electronic processor 540 to implement the functionality of the user device 108 described herein. Additionally, the memory 542 may store mobile device perimeter settings. The mobile device perimeter settings may include a subset of settings specific to each of the power tool devices 106 and/or power tool perimeter safety system 100 with which the user device 108 interacts or manages. As described herein, mobile device perimeter settings may include one or more predetermined actions that the electronic processor 540 should take in response to an indication that a boundary crossing has occurred, as described in further detail below. In some examples, the memory 542 may store a mapping of various particular actions that the electronic processor 540 should take in response to various types of additional information provided with an indication that a boundary crossing has occurred. Thus, the particular action(s) implemented by the electronic processor 540 can vary based on particular details of the boundary crossing, message, or other settings.

As illustrated in FIG. 5, in some configurations, the user device 108 may include the HMI 552 for interacting with a user. The HMI 552 may include one or more input devices, one or more output devices, or a combination thereof. Accordingly, in some configurations, the HMI 552 allows a user to interact with (e.g., provide input to and receive output from) the user device 108. For example, the HMI 552 may include a keyboard, a cursor-control device (e.g., a mouse), a touch screen, a scroll ball, a mechanical button, a display device (e.g., a liquid crystal display (LCD)), a printer, a speaker, a microphone, another type of input device, another type of output device, or a combination thereof. As illustrated in FIG. 5, in some configurations, the HMI 552 includes a display device 550. The display device 550 may be included in the same housing as the user device 108 or may communicate with the user device 108 over one or more wired or wireless connections. For example, in some configurations, the user device 108 can be a touchscreen device, a laptop computer, a tablet computer, or the like. In other configurations, the user device 108 is or includes a monitor, a television, or a projector coupled to a terminal, desktop computer, or the like.

In some examples, the HMI 552 provides a graphical user interface for the user to enter tool perimeter settings, which the user device 108 may transmit via the communication interface 544 to the power tool device 106 for storage on the memory 330, as discussed with respect to FIG. 3. For example, the graphical user interface may present a list or drop-down list of selectable actions that the power tool device 106 is to take in response to a boundary crossing. The user device 108 may then transmit the selected action(s) to the power tool device 106. Additionally or alternatively, the HMI 552 may provide a graphical user interface for the user to enter mobile device perimeter settings, which the user device 108 may store on the memory 542. For example, the graphical user interface may present a list or drop-down list of selectable actions that the user device 108 is to take in response to a boundary crossing. The user device 108 may then store the action(s) that were selected in the memory 542, and the electronic processor 540 may ultimately access the stored action(s) in response to receiving an indication of a boundary crossing and execute the action(s). Thus, a user is able to customize the particular actions taken by the user device 108 in response to a boundary crossing or type of boundary crossing.

Although the user device 108 is primarily described with respect to the power tool safety perimeter system 100, in some examples, the user device 108 may interact with and manage a plurality of power tool safety perimeter systems that are similar to the power tool safety perimeter system 100, in a similar manner as described herein.

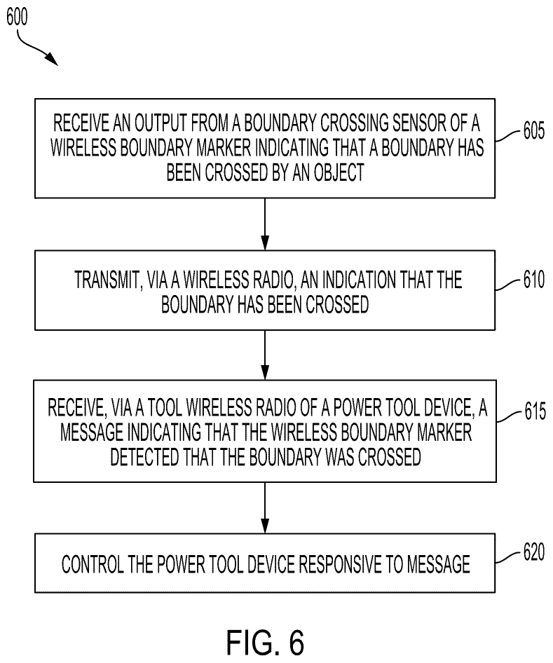

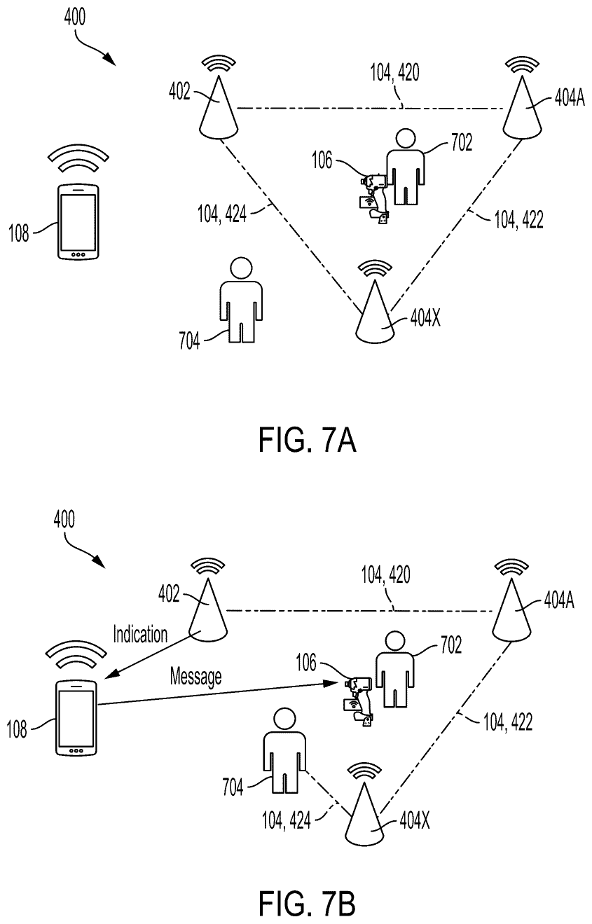

FIG. 6 illustrates a flowchart of process 600 for performing boundary sensing for one or more power tool devices. For illustration purposes, the process 600 is generally described as being implemented by the power tool safety perimeter system 100 in FIG. 1 and, more particularly, with the boundary marker system 400 of FIGS. 4 and 7A-B. However, in some embodiments, the process 600 is implemented by another system having addition components, fewer components, alternative components, etc. Although the blocks of the process 600 are illustrated in a particular order, in some embodiments, one or more of the blocks can be executed partially or entirely in parallel, can be executed in a different order than illustrated in FIG. 6, or can be bypassed.

In block 605, a marker electronic controller of a wireless boundary marker receives an output from a boundary crossing sensor of the wireless boundary marker, indicating that a boundary has been crossed by an object. For example, with reference to FIG. 4, the marker electronic controller 413 may receive an output from the sensor(s) 406 (e.g., an IR sensor of the sensor(s) 406) indicating that the perimeter 104 (a boundary) has been crossed by an object (e.g., a human, an animal, or an inanimate object). As previously described with respect to FIG. 4, the sensors 406, 414A, and 414X may transmit IR signals 420, 422, and 424, respectively, that collectively form the perimeter 104. FIG. 7A provides an additional illustration of an example of the system 400 of FIG. 4 in which the system 400 generates the perimeter 104 around a power tool device user 702 operating the power tool device 106. Also illustrated in FIG. 7A is an individual 704 that is outside of the perimeter 104 and the user device 108.

When an object crosses the perimeter 104 (e.g., is positioned between the first IR transmitter and the second IR receiver, between the second IR transmitter and the third IR receiver, or between the third IR transmitter and the first IR receiver), the first, second, or third IR signal is blocked from being received by the corresponding first, second, or third IR receiver. Ultimately, then, the perimeter 104 is broken and the master boundary marker 402 does not receive the third IR signal 424. For example, as illustrated in FIG. 7B, the individual 704 (an object) crosses the perimeter 104, blocking the third IR signal 424 from reaching the master boundary marker 402. In such a scenario, the first IR receiver of the first IR sensor (of the sensor(s) 102) of the master boundary marker 402 does not receive the third IR signal 424. Similarly, when the individual 704 crosses the perimeter 104 by blocking the second IR signal 422 or the first IR signal 420, the master boundary marker 402 does not receive the third IR signal 424, because the generation of each IR signal by a boundary marker 404A, 404X may be conditioned on that boundary marker 404A, 404X receiving the previous IR signal of the perimeter 104.

In response to not receiving the third IR signal 424, the first IR sensor of the master boundary marker 402 may transmit an output to the marker electronic controller 413 indicating that the perimeter 104 has been crossed. In contrast, when the first IR sensor receives the third IR signal 424 (e.g., as illustrated in FIG. 7A), the first IR sensor may transmit an output to the marker electronic controller 413 indicating that the perimeter 104 has not been crossed.

In some examples, the IR signals encode information (e.g., an identifier) and the master boundary marker 402 and/or auxiliary boundary marker 404A, 404X may analyze a received IR signal to determine whether information encoded in the received IR signal matches an expected value. In other words, the boundary markers 402, 404A, 404X may authenticate received IR signals. In these examples, the IR transmitters of the master boundary marker 402 and/or auxiliary boundary markers 404A, 404X may transmit their corresponding IR signals in response to determining that the information encoded matches the expected value. In these examples, the output from the first IR sensor of the master boundary marker 402 to the marker electronic controller 413 may include the information (if any) encoded in the third IR signal 424 (if received). The marker electronic controller 413 may then determine that the perimeter 104 has been crossed when the output indicates either that the first IR sensor did not receive an IR signal or that the first IR sensor received an IR signal that did not include encoded information that matched an expected value (e.g., an imposter or inauthentic IR signal was received).

In some examples, the boundary marker system 400 determines additional crossing information corresponding to a crossed boundary. For example, the boundary marker system 400 may determine a location of the crossed boundary along the perimeter 104. For example, when the boundary markers 402, 404A, 404X include multiple IR sensors for bidirectional communication between the boundary markers 402, 404A, 404X (see, e.g., IR signals 420 and 434, signals 422 and 432, and signals 424 and 430 in FIG. 4), the boundary markers 404A, 404X may communicate back information to the master boundary marker 402 even though an object may be blocking a segment of the perimeter 104. For example, the boundary markers 402, 404A, 404X may transmit acknowledge signals in response to receiving an IR signal. Thus, with reference to FIG. 7B, the boundary marker 404X may transmit a signal to the boundary marker 404A indicating no acknowledge signal was received from the boundary marker 402 (as the individual 704 is blocking communication), and the boundary marker 404A may transmit this information to the master boundary marker 402. The master boundary marker 402 may, in turn, determine that a boundary crossing of the perimeter 104 occurred between boundary markers 404X and 402.

Additionally or alternatively, in some examples, the boundary marker system 400 determines as additional crossing information: a time of the boundary crossing, a type of object that crossed the boundary, and/or whether the object that crossed the boundary is an individual with credentials. In some examples, to determine the time of the boundary crossing, the boundary marker system 400 may access a clock of the marker electronic controller 413 that keeps track of time. In some examples, determine a type of object that crossed the boundary, (i) the marker electronic controller 413 may infer a type of object based on a length of time that the boundary was crossed and/or between crossings of the boundary, and/or (ii) additional sensors may be included within the sensor(s) 406, 414A, 414X to identify objects (e.g., cameras, microphones, motions sensors), and the sensor outputs indicative of the type may be communicated to the marker electronic controller 413. In some examples, to determine whether the object that crossed the boundary is an individual with credentials, additional sensors may be included within the sensor(s) 406, 414A, 414X, such as, for example, proximity sensors configured to sense a wireless identifier (ID) badge of credentialed individuals. Thus, for example, if the master boundary marker 402 determines that the perimeter 104 is crossed simultaneously or in parallel with a proximity sensor indicating that a credentialed individual is proximate one or more of the boundary markers 402, 404A, 404X, the master boundary marker 402 may infer that the boundary crossing was due to a credentialed individual. In the alternative, if the proximity sensor does not indicate that a credentialed user is proximate, the master boundary marker 402 may infer that the boundary crossing was due to a noncredentialled object. In some examples, other techniques are used to determine whether an object is a credentialed individual. For example, the master boundary marker 402 may determine whether an object is a credentialed individual based on the individual's identification, any safety certifications held by the individual, any detected safety gear worn by the individual, or the like. As described further below, this additional crossing information may impact resulting actions by the power tool safety perimeter system 100.

Returning to FIG. 6, in block 610, a wireless radio of the boundary marker transmits an indication that the boundary has been crossed. For example, with reference to FIG. 4, the marker electronic controller 413 may generate and send the indication via the marker wireless radio 409 in response to determining that the perimeter 104 was crossed in block 605. In some examples, the indication may be transmitted to a wireless radio of the power tool device 106. For example, the marker electronic controller 413 may transmit the indication wirelessly to the wireless communication interface 355 of the power tool device 106 (see FIG. 3). In some examples, additionally or alternatively, the indication may be transmitted to a wireless radio of a mobile device (e.g., the user device 108). For example, with reference to FIG. 5, the user device 108 (e.g., the electronic processor 540) may receive the indication wirelessly via the communication interface 544.

The indication may include additional information regarding the boundary crossing (e.g., the additional crossing information discussed above). For example, the indication may identify the type of object that crossed the boundary (i.e., debris, a vehicle, an animal, an individual, etc.), a location of the crossing (e.g., which section of the perimeter 104 was crossed), a time in which the crossing occurred, whether the object that crossed the boundary was a credentialed user, or the like.

In block 615, a tool wireless radio of a power tool device receives a message indicating that the wireless boundary marker detected that the boundary was crossed. For example, with reference to FIG. 3, the wireless communication interface 355 of the power tool device 106 may receive the message wirelessly. In some examples, the power tool device 106 may receive the message from the boundary marker (e.g., the master boundary marker 402), where the marker electronic controller 413 transmits the message via the marker wireless radio 409. In such examples, the message may be the indication transmitted in block 610. In some examples, the power tool device 106 may receive the message from a mobile device (e.g., the user device 108). For example, the user device 108 may receive the indication transmitted in block 610. In response to receiving the indication, the user device 108 may transmit the message to the power tool device 106.

In addition to indicating that the boundary was crossed, the message may include additional information regarding the boundary crossing including one or more of: an identification of the boundary marker that transmitted the indication in block 610, an identification of the user device 108, an identification of the sender of the message, an identifier of the power tool device 106 receiving the message, one or more commands for the power tool device 106, the additional crossing information discussed above, and/or other identification information that may be used by the power tool device 106 to determine an action to perform in response to the message. The one or more commands may specify, for example, that the power tool device 106 generate an alert (e.g., an audible, visual, and/or tactile alert generated, respectively, by a light emitting diode, speaker, and/or vibrating element of the electronic components 350), slow or reduce rotation speed of a motor of the electronic components 350, or stop rotation of a motor of the electronic components 350. Unless otherwise noted, slowing or reducing rotation speed of a motor may include slowing the motor to a non-zero rotation speed or slowing the motor to a stop.

In block 620, a controller of the power tool can control the power tool device in response to the message. For example, with reference to FIG. 3, the electronic controller 310 may control the electronic components 350 of the power tool device 106 based on the message. In some examples, the message includes one or more commands that indicate the action or control that the electronic controller 310 is to execute. For example, the message may indicate to the electronic controller 310 to generate an alert (e.g., an audible, visual, and/or tactile alert generated, respectively, by a light emitting diode, speaker, and/or vibrating element of the electronic components 350), slow or reduce rotation speed of a motor of the electronic components 350, or stop rotation of a motor of the electronic components 350. In some examples, the memory 330 of the electronic controller 310 stores predetermined actions that the electronic controller 310 is to take in response to the message. Like the example commands noted, these predetermined actions may be, for example, to generate an alert, slow or reduce rotation speed of a motor of the electronic components 350, or stop rotation of a motor of the electronic components 350.

In some examples, the memory 330 stores a set of predetermined actions, and the electronic controller 310 accesses the memory 330 to determine a particular action or actions of the set of predetermined actions to be taken based on the message or additional information thereof. For example, as noted above, the message may include additional information regarding the boundary crossing including one or more of: an identification of the boundary marker that transmitted the indication in block 610, an identification of the user device 108, an identification of the sender of the message, an identifier of the power tool device 106 receiving the message, one or more commands for the power tool device 106, and/or the additional crossing information. This additional information may map to a particular action or actions that the electronic controller 310 should take to control the power tool device 106. For example, the memory 330 may store a lookup table that maps potential values for the additional information to a particular action or actions. Thus, the particular control implemented by the controller of the power tool in block 620 can vary based on, for example, an identity of the boundary marker that sent the message, an identify of the user device that sent the message, whether the message was sent by the boundary marker or a user device, an indication of the section of the perimeter 104 where the boundary was crossed, or the like. Thus, in some examples, the electronic controller 310 may determine based on receipt of the message that action should be taken, and then determine based on the additional information of the message which particular action(s) to take.

In some examples of the process 600, multiple power tool devices 106 are controlled. For example, in block 615, the message indicating that the boundary was crossed may be received by multiple power tool devices 106 associated with the perimeter 104 (e.g., operating within the perimeter 104). In some of these examples, the user device 108 sends the message, which may be a broadcast message that multiple power tool devices 106 receive or may include multiple messages that are individually sent to the multiple power tool devices 106. In the latter example, the user device 108 may be configured in advance (e.g., during a setup stage) with a list of identities of the power tool devices 106 that should receive a message in the event of a boundary crossing. Then, in the event of a boundary crossing, the user device 108 (e.g., the electronic processor 540) may access that list (e.g., in the memory 542) to determine to which power tool devices 106 to transmit the message and then to transmit these messages. Following this same example, the electronic controller 310 of each power tool device 106 that receives the message transmitted in block 615 may then control the power tool device 106 in block 620, as described above. Thus, in one example, when the perimeter 104 is crossed, each power tool device 106 associated with that perimeter 104 may be controlled to generate an alert, slow its motor, and/or stop its motor.

In some examples of the process 600, when the user device 108 receives the indication transmitted by the wireless boundary marker in block 610, the user device 108 may generate an alert. The alert may be perceptible by a user of the power tool device 106 (e.g., the power tool device user 702). For example, the alert may be a visual alert displayed on a display of the user device 108, an audible alert generated by a speaker of the user device 108, and/or a tactile alert generated by a vibration element of the user device 108. In some examples, this alert may be in addition to transmitting the message to the power tool device 106 that is ultimately received in block 615. In other examples, this alert may be generated and blocks 615 and 620 of the process 600 may be bypassed.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature can sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components can be consolidated and performed by a single component. Similarly, the functions described herein as being performed by one component can be performed by multiple components in a distributed manner. Additionally, a component described as performing particular functionality can also perform additional functionality not described herein. For example, a device or structure that is “configured” in a certain way is configured in at least that way, but can also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications can be made to these configurations without departing from the scope or spirit of the claimed subject matter.

Certain operations of methods according to the disclosure, or of systems executing those methods, can be represented schematically in the figures or otherwise discussed herein. Unless otherwise specified or limited, representation in the figures of particular operations in particular spatial order can not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” etc. are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions can be used to discuss aspects of a particular example or figure, but do not necessarily require similar orientation or geometry in all installations or configurations.

As used herein, unless otherwise defined or limited, the phase “and/or” used with two or more items is intended to cover the items individually and the items together. For example, a device having “a and/or b” is intended to cover: a device having a (but not b); a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The following detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. A power tool safety perimeter system comprising:
a wireless boundary marker comprising:
a boundary crossing sensor;
a marker wireless radio;
a marker electronic controller including a first processor and coupled to the boundary crossing sensor and the marker wireless radio, the marker electronic controller configured to:
receive an output from the boundary crossing sensor indicating that a boundary has been crossed by an object, and
transmit, via the marker wireless radio, an indication that the boundary has been crossed; and
a power tool comprising:
a motor;
a tool wireless radio; and
an electronic tool controller including a second processor and coupled to the motor and the tool wireless radio, the electronic tool controller configured to:
receive a message, via the tool wireless radio, indicating that the wireless boundary marker detected that the boundary was crossed, and
control the power tool responsive to the message.

2. The system of claim 1, wherein the message received by the electronic tool controller is the indication transmitted by the marker electronic controller of the wireless boundary marker.

3. The system of claim 1, further comprising:
a wireless mobile device comprising:
a mobile device wireless radio;
an electronic mobile device controller including a third processor coupled to the mobile device wireless radio, the electronic mobile device controller configured to:
receive, via the mobile device wireless radio, the indication that the boundary has been crossed; and
transmit, via the mobile device wireless radio, the message to the power tool.

4. The system of claim 3, wherein the wireless mobile device further comprises a display, and where the electronic mobile device controller is further configured to:
receive, from a user via a graphical user interface on the display, response settings that indicate one or more actions to be implemented by the wireless mobile device in response to receiving the indication that the boundary has been crossed;
store the response settings; and
in response to receiving the indication that the boundary has been crossed, implement the one or more actions.

5. The system of claim 1, wherein, to control the power tool responsive to the message, the electronic tool controller is configured to at least one selected from a group of stop the motor, slow the motor, or generate an alert.

6. The system of claim 1, further comprising:
auxiliary wireless boundary markers, each of the auxiliary wireless boundary markers including respective auxiliary boundary crossing sensors,
wherein the boundary crossing sensor and the auxiliary boundary crossing sensors form a virtual perimeter.

7. The system of claim 6, wherein the boundary crossing sensor and the auxiliary boundary crossing sensors are infrared sensors that each include an infrared transmitter and an infrared receiver.

8. The system of claim 7, wherein the boundary crossing sensor sends the output upon the infrared receiver detecting an interruption in a received infrared signal.

9. The system of claim 6, wherein the boundary crossing sensor and the auxiliary boundary crossing sensors are each a link in a daisy-chain that forms the virtual perimeter, and wherein the boundary crossing sensor is configured to generate the output indicating that the boundary has been crossed by the object when the object crosses the virtual perimeter and interrupts the daisy-chain.

10. The system of claim 1, wherein the marker electronic controller is configured to:
determine that the boundary has been crossed by the object;
determine whether the object is a credentialed individual; and
transmit the indication that the boundary has been crossed in response to determining that the object is not a credentialed individual.

11. The system of claim 1, wherein the message further indicates a time and a location that the boundary was crossed.

12. A method comprising:
receiving, by a marker electronic controller of a wireless boundary marker, an output from a boundary crossing sensor of the wireless boundary marker indicating that a boundary has been crossed by an object;
transmitting, via a wireless radio of the wireless boundary marker, an indication that the boundary has been crossed;
receiving, via a tool wireless radio of a power tool device, a message indicating that the wireless boundary marker detected that the boundary was crossed; and
controlling, by an electronic tool controller of the power tool device, the power tool device responsive to the message.

13. The method of claim 12, further comprising transmitting by an electronic controller of the wireless boundary marker, the output.

14. The method of claim 12, further comprising:
receiving, via a mobile device wireless radio, the output from the boundary crossing sensor of the wireless boundary marker indicating that the boundary has been crossed; and
transmitting, via the mobile device wireless radio, the message to the power tool device.

15. The method of claim 14, further comprising:
receiving, from a user via a graphical user interface of a display of the wireless mobile device, response settings that indicate one or more actions to be implemented by the wireless mobile device in response to receiving the output that the boundary has been crossed;
storing the response settings; and
implementing the one or more actions in response to receiving the output that the boundary has been crossed.

16. The method of claim 12, wherein controlling the power tool device responsive to the message comprises at least one selected from a group of:
slowing a motor of the power tool device,
stopping the motor of the power tool device, or
generating an alert.

17. The method of claim 12, further comprising:
forming a virtual perimeter using one or more auxiliary wireless boundary markers, wherein each of the auxiliary wireless boundary markers includes one or more respective auxiliary boundary crossing sensors.

18. The method of claim 17, further comprising:
transmitting, using one or more infrared sensors of the boundary crossing sensor and the one or more auxiliary boundary crossing sensors, an infrared light; and
receiving, by an infrared receiver, the transmitted infrared light.

19. The method of claim 12, further comprising:
determining that the boundary has been crossed by the object;
determining whether the object is a credentialed individual; and
transmitting the output that the boundary has been crossed in response to determining that the object is not a credentialed individual.

20. The method of claim 12, further comprising:
determining a type of object; and
indicating a time and a location associated with the object crossing the boundary.
